(19) United States
(12) Patent Application Publication
(10) Pub. No.: US 2019/0241278 A1
(43) Pub. Date: Aug. 8, 2019

(54) HELICOPTER AND WINDOW LIGHTS

(71) Applicant: Maurice A. Khawam, Lakewood, CA (US)

(72) Inventor: Maurice A. Khawam, Lakewood, CA (US)

(21) Appl. No.: 16/254,534

(22) Filed: Jan. 22, 2019

Related U.S. Application Data
(63) Continuation-in-part of application No. 14/999,817, filed on Jul. 1, 2016, now Pat. No. 10,220,959.

(51) Int. Cl. B64D 47/02; F21S 10/02; F21S 10/06; F21S 41/13

(52) U.S. Cl. CPC B64D 47/02; F21S 10/02; F21W 2107/30; F21S 41/13; B64D 2203/00; F21S 10/06

(57) ABSTRACT

The present invention is a lighting system for helicopters, airplanes and windows. In particular, the present invention is directed to a lighting system that illuminates portions of a helicopter, airplane, or a building's windows to deter bird strikes. The helicopter system has a light mounted on the tail aimed at the tail rotor, where illumination from the light comprises ultraviolet light and the tail light flashes at a pre-determined frequency. The tail rotor preferably has a surface at least partially coated in fluorescent paint that shifts the ultraviolet light to light visible to humans such as violet light (e.g. 400-445 nm). The light is preferably mounted on a roundel having alternating fluorescent paint and reflective surfaces. The lighting system can also have a main rotor light and a belly light mounted on roundels.

### TECHNICAL FIELD

The present invention is a lighting system for helicopters, airplanes and windows. In particular, the present invention is directed to a lighting system that illuminates portions of a helicopter, airplane or a building's windows to deter bird strikes. This application is a continuation-in-part of U.S. patent application Ser. No. 14/999,817, which is included by reference in its entirety.

### BACKGROUND ART

A current problem in the aviation industry is the incidence of bird strikes on aircraft. It has been estimated that these incidents cost the airline industry $1.2 billion dollars annually in losses, delays and cancellations. On average, each bird strike costs an airline approximately: $40,000. This total does not include bird strike losses to helicopters or general aviation or military aviation.

Military losses in western nations are difficult to estimate. However, between 1959 and 1999, at least 283 military aircraft were lost due to bird strikes including 141 deaths. Today, aircraft use larger engines with very high by-pass ratios. Aircraft engine frontal surfaces have increased considerably over older ones. This makes aircraft engines more susceptible to bird ingestion. Moreover, engines have to be designed to withstand bird strikes. This has necessitated the installation of heavier engine components. Accordingly, the additional weight causes higher fuel consumption and creates more pollution into the upper atmosphere.

Airports and their municipalities bear the majority of the cost of bird strikes. Airport wildlife management costs can exceed $100,000 per year. The airlines and aircraft manufacturers that benefit from the implemented measures to reduce bird strikes have not contributed adequately to minimize the occurrence of these incidents. Accordingly, an aircraft lighting system is needed that can reduce or eliminate bird strikes without imposing a heavy financial burden on the airlines or airports.

### SUMMARY OF THE INVENTION

The present invention is a lighting system for helicopters, airplanes and windows. In particular, the present invention is directed to a lighting system that illuminates portions of a helicopter, airplane, or a building's windows to deter bird strikes. The helicopter system has a light mounted on the tail aimed at the tail rotor, where illumination from the light comprises ultraviolet light and the tail light flashes at a pre-determined frequency. The tail rotor preferably has a surface at least partially coated in fluorescent paint that shifts the ultraviolet light to light visible to humans such as violet light (e.g. 400-445 nm). The light is preferably mounted on a roundel having alternating fluorescent paint and reflective surfaces. The lighting system can also have a main rotor light and a belly light mounted on roundels.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1a is a top view of a schematic showing a preferred embodiment location of lights positioned on the fuselage and engine nacelles of a jet with lines depicting light cast;

FIG. 1b is a side view of a schematic showing a preferred embodiment location of lights positioned on the fuselage and engine nacelles of a jet with lines depicting light cast;

FIG. 1c is a front view of a schematic showing a preferred embodiment location of lights positioned on the fuselage and engine nacelles of a jet with lines depicting light cast;

FIG. 2a is a side view schematic of a preferred embodiment light installation on a jet fuselage;

FIG. 2b is a side perspective view schematic of a preferred embodiment light installation on a jet engine nacelle;

FIG. 2c is a closer detailed view of FIG. 2a;

FIG. 2d is a side view schematic of a preferred embodiment installation of retractable light installation on a smaller jet aircraft;

FIG. 2e is a top view schematic of a preferred embodiment installation on a rear engine aircraft with lines depicting light cast;

FIG. 3 is a front perspective view schematic showing preferred embodiment locations of lights positioned inside an engine inlet and on the engine pylon with lines depicting light cast;

FIG. 4 is a front perspective view schematic showing an alternate embodiment locations of lights positioned inside an engine inlet with lines depicting light cast;

FIG. 5a is a schematic depicting a preferred embodiment flashing sequence overlap of 2 lights at 2 Hz;

FIG. 5b is a schematic depicting a preferred embodiment flashing sequence overlap of 2 lights at 3 Hz;

FIG. 6 is a block diagram depicting a preferred sequence for turn-on and turn-off control of the lights;

FIG. 7 is a side cross-sectional view schematic showing a preferred embodiment light installation on an engine nose cone;

FIG. 8 is a top view schematic of a preferred embodiment electrical installation of the lights and controls;

FIG. 9 is a block diagram of preferred embodiment of the electrical system;

FIG. 10 is a diagram showing the wavelength and frequency distribution of ultraviolet light seen only by birds compared to visible light seen by humans;

FIG. 11 is a graph that shows ultraviolet light absorbance of birds' vision;

FIG. 12 is a side view schematic depicting a preferred embodiment of a flashing lights installation on a wind turbine hub;

FIG. 13 is a front perspective view schematic depicting a preferred embodiment of the invention with a row of flashing lights to compensate for variable blade pitch with a circle depicting blade path;

FIG. 14 is a side perspective view of a preferred embodiment of a retractable arm assembly for the present invention in a retracted position;

FIG. 15 is a side perspective view of a preferred embodiment of a retractable arm assembly for the present invention in a deployed position;

FIG. 16a is a top view of a preferred embodiment of the present invention installed on a twin engine propeller aircraft;

FIG. 16b is a front view of a preferred embodiment of the present invention installed on a twin engine propeller aircraft;

FIG. 17a is a side view of a preferred embodiment of the present invention installed on a single engine propeller aircraft;

FIG. 17b is a front view of a preferred embodiment of the present invention installed on a single engine propeller aircraft;

FIG. 18 is a side perspective view of a preferred embodiment of the present invention installed on a helicopter tail rotor;

FIG. 19 is a side view of a preferred embodiment of the present invention installed on an unmanned aerial vehicle (UAV);

FIG. 20 is a perspective front view of a preferred embodiment of the present invention installed on a helicopter;

FIG. 21 is a perspective front view of a preferred embodiment of the present invention installed on a helicopter with a coweled tail rotor;

FIG. 22 is an exploded view schematic of the present invention in a coweled tail rotor;

FIG. 23 is a top view of a preferred embodiment of a roundel;

FIG. 24 is a top view of a preferred alternative airplane lighting system installed on an airplane;

FIG. 25 is a front view of a preferred embodiment LED lamp for use with these embodiments;

FIG. 26 is a front view of a preferred embodiment of the present invention installed in a building window pane; and,

FIG. 27 is a front perspective view of a preferred installation of the present invention on a building.

### DETAILED DESCRIPTION OF THE PREFERRED EMBODIMENTS

The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide an aircraft lighting system.

Even on sunny days, engine inlets, particularly fan blades, are often partially obscured. Typically, only an outer lip of the engine inlet is made of light colored metal (e.g. aluminum) and is clearly visible.

Generally, the present invention comprises strategically installed lights on aircraft to illuminate its entire engines inlets. Thus, the lights make the engine inlets, particularly the rotating fan blades, more visible to birds. Given that sound travels at approximately 300 m/sec. in air and light travels at approximately 300,000,000 m/sec. (or 1 million times faster), this discrepancy can be used to visually alert birds of an in-coming aircraft with light much more rapidly than sound. Birds generally have keen eyesight and an engine inlet that is more easily visible to birds will result in an increased chance of being avoided than a dark engine inlet. Airport environments are typically very noisy due to various aircraft activities as well as the movement of ground support equipment. Birds will be able to quickly associate the sound source of a particular aircraft with the light emissions of the present invention and clearly identify the location of the aircraft engine inlets and avoid them.

Existing aircraft landing, anti-collision and navigation lights are not sufficient or large enough to prevent bird strikes on aircraft, particularly engine inlets. The present invention can be mounted on an aircraft fuselage and its engine nacelles to aim focused beams of light through lenses towards the aircraft's engine inlets.

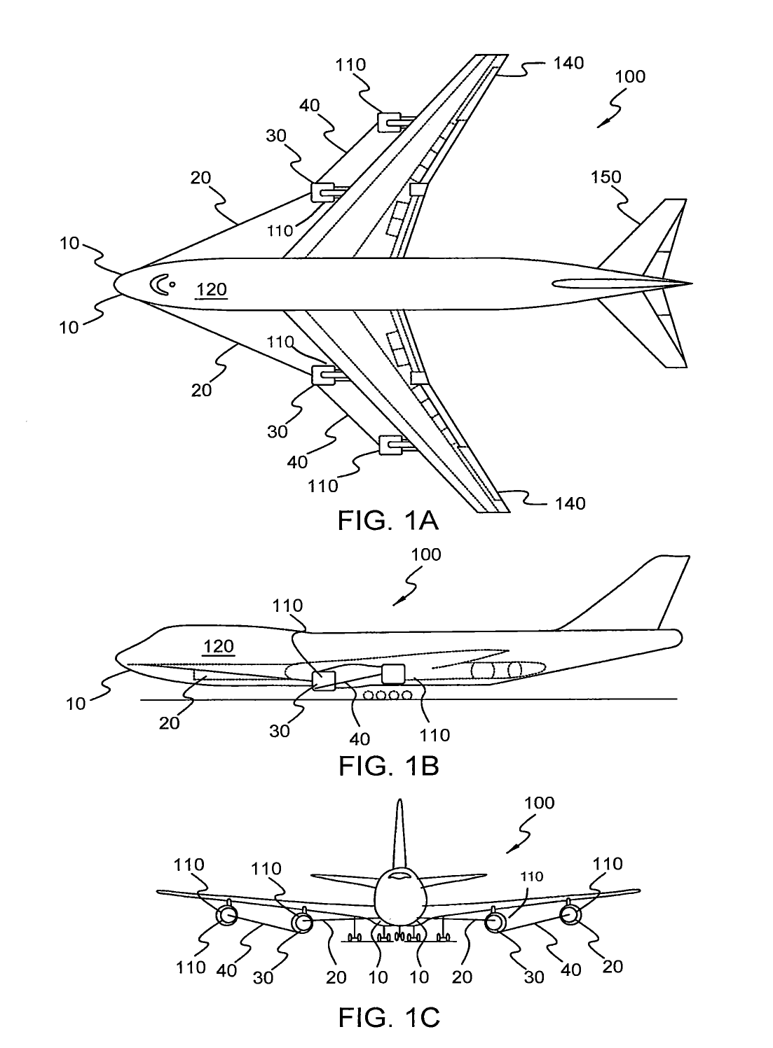

Referring now to FIG. 1a, a four engine jet aircraft 100, namely a Boeing 747, is shown. The aircraft 100 has four engine nacelles 110. In the preferred embodiment shown in FIG. 1a, lights 10 are mounted on the fuselage 120 of the aircraft 100 and aimed at the engine nacelles 110 as shown by rays 20. Nacelle lights 30 are also preferably mounted on the interior engine nacelles 110 to shine on the outer engine nacelles 110 along rays 40. FIG. 1b shows a side view and FIG. 1c shows a front view of this arrangement.

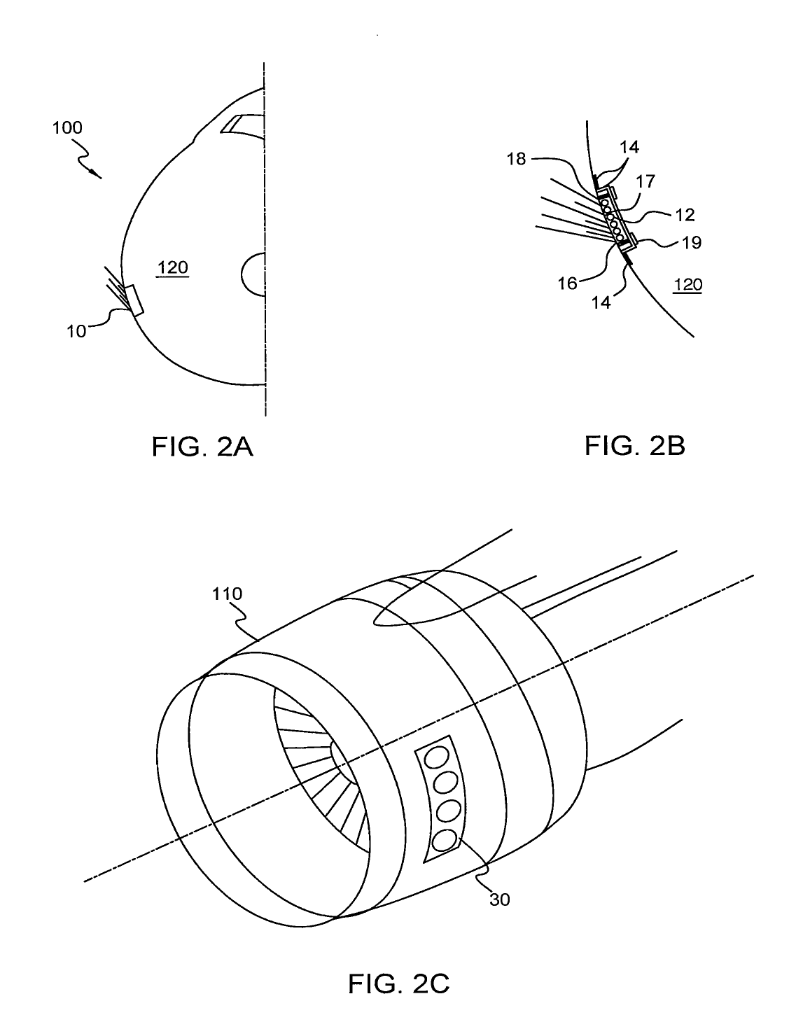

Referring now to FIG. 2a, a preferred embodiment of the fuselage lights 10 mounted on the aircraft fuselage 120 is shown. Preferably, the lights 10 are mounted flush with the fuselage 120 and flash periodically on the engine inlet of the engine nacelle 110 (not shown).

Referring now to FIG. 2b, a preferred embodiment of the nacelle lights 30 mounted on the exterior of an engine nacelle 110 is shown. Preferably, the nacelle lights 30 are mounted flush with the nacelle 110 and flash periodically on an exterior engine nacelle 110 (not shown). In the preferred embodiment shown in FIG. 2b, the nacelle lights 30 shown are four light-emitting diodes (LEDs). However, as shown below, other lights such as Xenon gas lamps can be used.

Referring now to FIG. 2c, a closer view of a preferred embodiment of the fuselage lights 10 mounted on the aircraft fuselage 120 is shown. Preferably, the fuselage lights 10 are mounted flush on the fuselage 120. The fuselage light 10 preferably comprise LED bulbs 12 mounted inside a frame 14 on the fuselage 120. Preferably, a perforated plate 16 and glass panel 18 cover the LED bulbs 12 and are attached to the frame 14 by bolts 19. The perimeter of the light assembly 10 is preferably made water and weather resistant by a seal 17. The seal 17 is preferably a rubberized seal suitable for the aircraft environment such as the type used as an anti-ice precaution on the leading edges of aircraft wings.

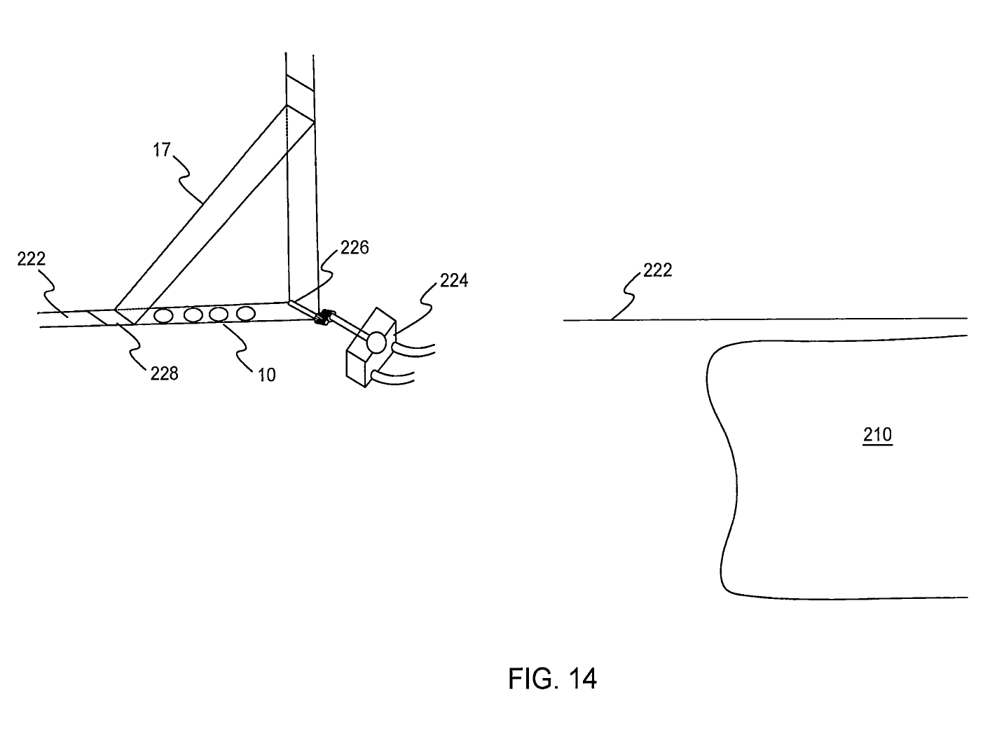

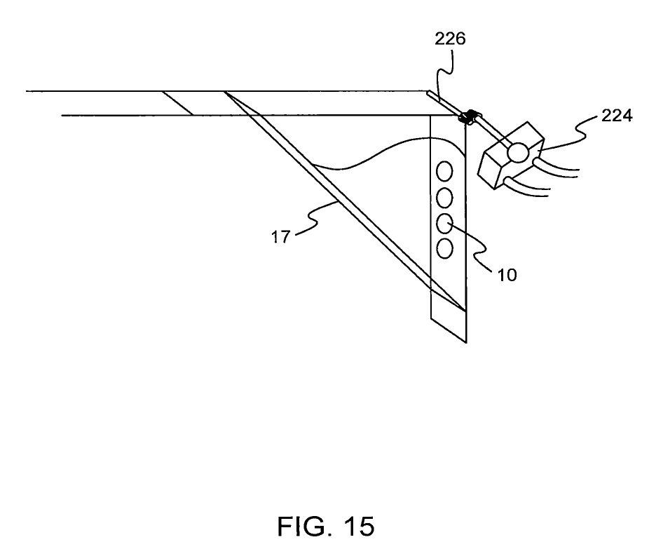

Referring now to FIG. 2d, an alternate embodiment of the present invention is shown installed on a smaller jet, such as a military fighter jet. The embodiment shown in FIG. 1d can be used when the distance between the light 10 and the engine 210 is not sufficiently large. The lights 10 are preferably mounted on a retractable arm 15 that is preferably only extended during take-off and landing phases or as required by a pilot. A preferred embodiment of the retractable arm assembly is shown in FIGS. 14 and 15. When retracted, the arm 15 is preferably held inside the floor 222 of the fuselage 220 and seal 228. Preferably, an electric motor 224 (controlled in the cockpit) drives gears and bearings 226 is used to raise and lower the assembly comprising the arm 15, lights 10 and support arm 17.

Referring now to FIG. 2e, an alternative embodiment of the present invention is shown for use on planes 300 with rear engine nacelles 310, such as the Boeing 727 shown. Lights 10 are preferably mounted on the fuselage 320. The lights 10 preferably periodically flash on the inlets of the engine nacelles 310 along rays 20 shown.

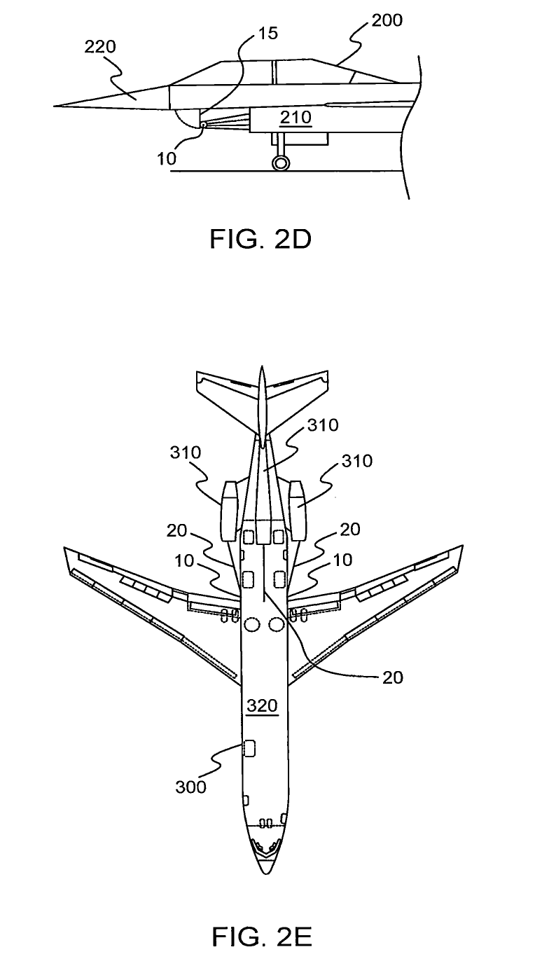

Referring now to FIG. 3, nacelle lights 30 can alternatively be positioned inside an engine inlet 115. As shown in FIG. 30, the lights 30 are preferably mounted on a colder section of the inlet 115 that is not a source of ignition. The lights 30 are preferably mounted flush with the inlet 115 so as not to interfere with the flow of air into the engine nacelle 110. The lights 30 are preferably angled to shine on fan blades 117 that rotate clockwise or counter-clockwise in the nacelle 110. A pylon light 35 can also, space permitting, be installed on an engine pylon 130 to flash forward on top of the nacelle 110.

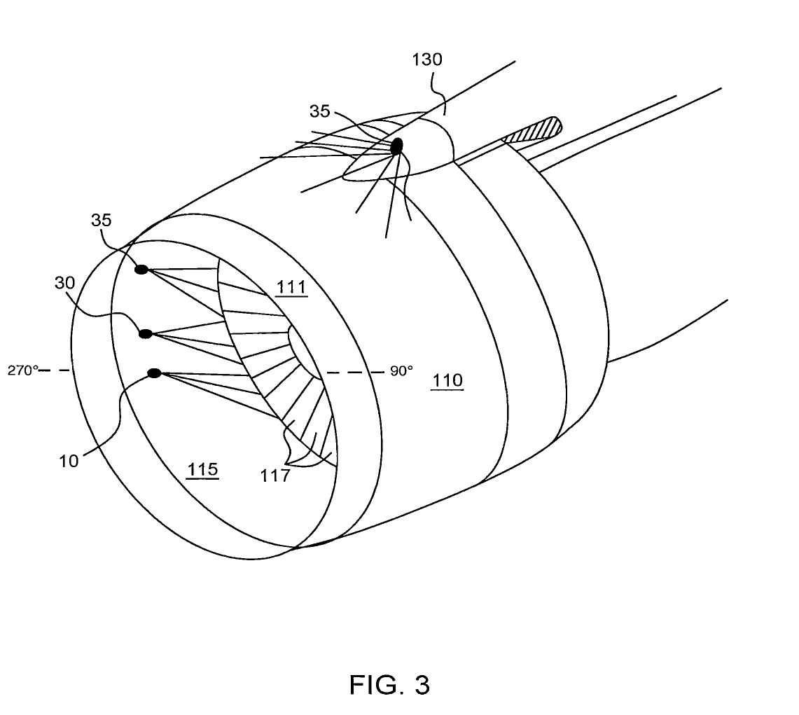

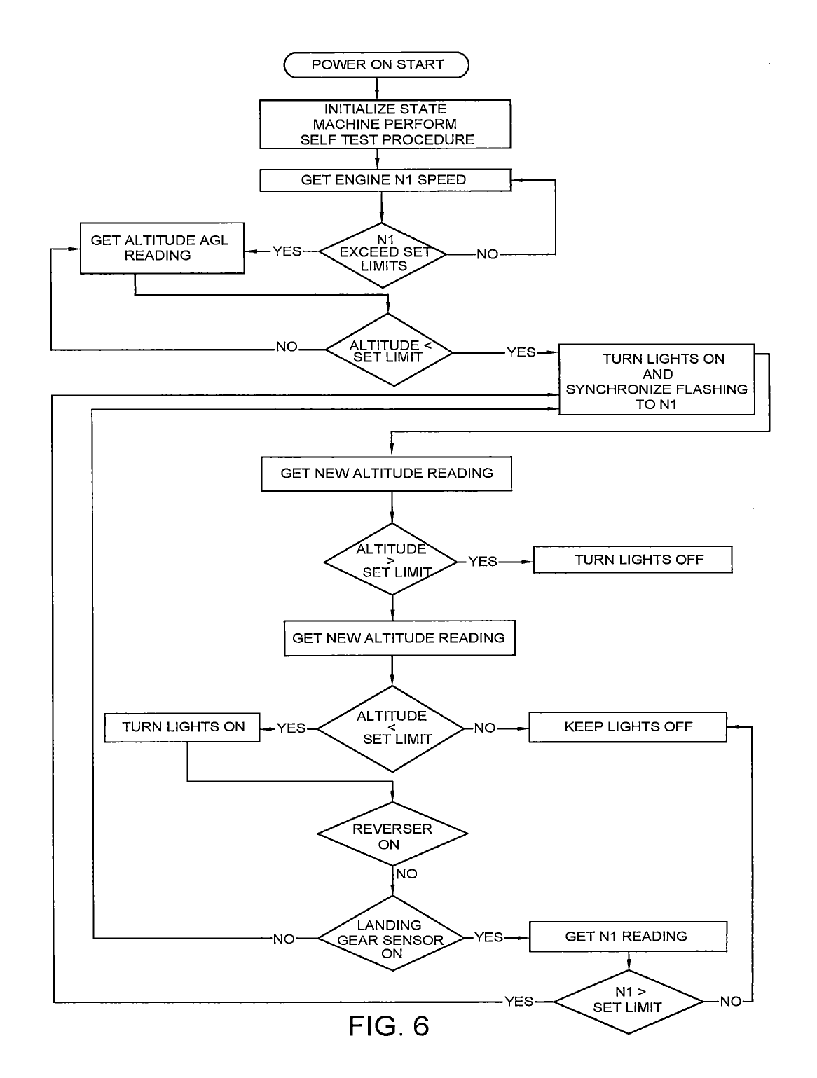

Referring now to FIG. 4, an alternative embodiment of the present invention is shown. In FIG. 4, nacelle lights 30 can also be preferably installed flush around an engine inlet 115 as shown. Referring now to FIG. 7, another alternative embodiment is shown where nacelle lights 30 are preferably installed flush on the engine nose cone 119 (preferably under glass affixed thereto). The lights 30 shine along rays 32 on the fan blades 117 to illuminate the blades 117.

Typically, prior art aircraft lighting has outward shining aircraft lights installed on the airframe and outside the engine inlets. The present invention preferably has light installations that shine on engine inlets and fan blades to make the inlets and fan blades more visible to birds. While aircraft fuselages and wings can typically sustain bird strikes and continue to fly, an engine strike can impose tremendous thermal and structural stresses on the rotating fan blades, possibly damaging them or breaking them off, which will result in catastrophic failure that endangers the flight. Aircraft engines are typically the most vulnerable components of an aircraft to damage from bird strikes.

Preferably, the lights 10 and 30 will have varying flashing frequencies as a function of fan speed, as well as different color(s) and pattern(s) of projection. Research has shown that a varying flashing frequency from 0.1 Hz to 3.0 Hz is very effective to capture the attention of birds. The higher flashing frequencies heighten a bird's survival instinct and cause them to fly away from the aircraft. The maximum flashing frequency disclosed by this invention are preferably employed when the engine's are at take-off speed and the flashing rate of the lights is proportional to the fan speed of the engines. Alternately, the system can maintain the maximum flashing frequency as a constant when the lights are powered on, independent of whether the phase of a given flight, e.g. take-off, landing, or in-flight.

The lights 10 and 30 of the present invention, like prior art logo lights that illuminate the rudder of an aircraft, also make the fuselage 120, wings 140 and tail 150 more visible to birds and will reduce bird strike incidents. The lights 10 and 30 also will make the aircraft more visible to tower personnel and pilots of other aircraft on take-off or during approach to landing. This is accomplished without added risks of impacting the vision of other pilots or airport workers.

The present invention preferably does not present a significant weight penalty to the aircraft and does not impose a high electric load on the aircraft generation system. Aircraft utilizing this invention would typically have electric consumption levels on the order of 100-150 watts or less per light. This is much lower than prior art landing or logo lights currently installed on aircraft, typically rated at 400-600 watts each. The present invention will chiefly be used during the take-off and approach to landing phases of the flight, although they can be turned on/off at anytime. By mounting the lights flush with the engine inlet 115 or fuselage 120, the lights 10 and 30 will not cause parasitic drag on the airframe. The present invention can preferably be retrofitted to existing commercial and military aircraft or incorporated directly into the construction of future aircraft.

### Operation Regimes

The present invention has a number of preferred methods of operation. Typically, the flight of an aircraft has different phases, e.g. departure or take-off; in-flight; and descent, approaching to landing, or landing.
Method 1:
   On Departure:
      a. Lights illuminate in steady state or solid when engines are powered on. Lights then become stroboscopic to synchronize with the fan speed of the engines (N1) after engine start.
      b. Lights remaining powered on and stroboscopic until the aircraft's flaps are completely retracted.
   On Descent:
      a. Lights illuminate when cabin pressurization decreases to a pre-determined level and remain illuminated until engine shut-down. When illuminated, lights are preferably synchronized to N1.
      b. If the flight is forced into a “go-around” or “touch and go” situation, lights stay illuminated until flaps are retracted completely.
Method 2:
   On Departure or Descent:
      a. Lights illuminate when powered on via a dedicated cockpit switch, e.g. on take-off and/or landing, by cockpit crew as part of a pre-determined checklist. When powered on, the lights preferably are synchronized to N1.
      b. The lights can then be turned on or off by the cockpit crew at any point in the flight, e.g. a pre-determined altitude as set by a checklist.
Method 3:
   On Departure:
      a. At push back and taxi, the lights are preferably off. When take-off roll begins, the lights illuminate when N1 exceeds 75% of maximum or when the engines are set to “take-off” power. The lights preferably remain illuminated until the aircraft climbs through 10,000 ft above ground level (“AGL”) or any other altitude selected by an operator. The lights are powered off automatically upon reaching the pre-determined altitude.
   On Descent:
      b. Upon descent below 10,000 ft AGL (or any other altitude selected by operator), the lights illuminate and stay illuminated until touch down on the runway. The lights can be powered off automatically at brake application or by a landing gear compression sensor. The lights then preferably remain off even if engine power is increased due to the deployment of the thrust reversers.

### Description of Lights and Installation of Lights in Engine Inlets and Fuselages

Referring now back to FIG. 3, nacelle lights 30 can be positioned as single or multiple rows anywhere inside the engine inlet 115, ahead of the fan blades 117 and on or behind the fan case lip 111 in order to shine on fan blades 117 and other inner surfaces of the engine inlet 115. However, preferably, the ideal arc is from 270 deg. to 90 deg. where clockwise is measured from 0 deg. at top center of the engine inlet 115. This half circle allows flexibility in positioning the lights 30 in order to avoid ducts and wiring (not shown) behind inner surfaces of the engine inlet 115. Additionally, locating lights 30 in this arc will help avoid damage from steps, ice, snow, FOD (Foreign Object Damage) and sand.

Preferably, when the lights of the present invention are illuminated, they are flashed. The flashing frequency is preferably governed by the engine speed, e.g. N1. For example if N1 is 3600 RPM, the lights (e.g. 10, 30, or 35) can be made to flash once every 30 revolutions of the fan blades 117. Thus, the lights flash at two flashes per second or a flashing frequency of 2 Hz. The lights' flashing frequency can also preferably be set manually using a frequency control as required. Alternatively, flashes from individual rows of lights can be made to occur separately from other rows or simultaneously.

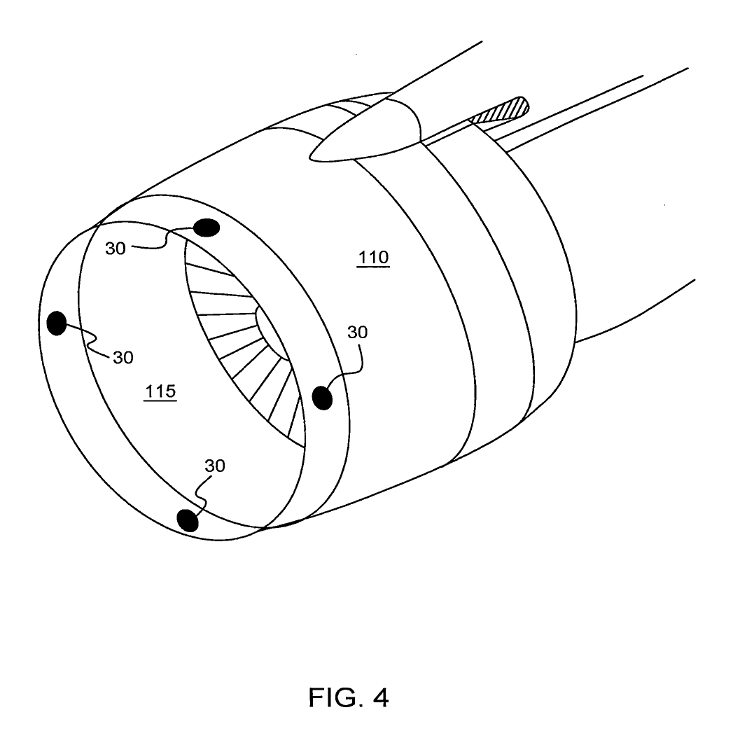

The lights of the present invention (e.g. 10, 30, 35, etc.) can have different colors and hues, e.g. orange (590 nm) and violet (400 nm) or white and violet. These colors/hues can be alternating or fixed in nature. An illumination or flashing sequence of the lights is preferably such that the flashes of different lights overlap for a fraction of a second with one another in order to avoid periods of darkness. Referring now to FIG. 5a, a graph of a preferred illumination or flashing sequence is shown with lights flashing at 1 Hz and 2 Hz Respectively. Referring next to FIG. 5b, a graph of another preferred illumination sequence is shown with lights flashing at 1 Hz and 3 Hz respectively. The periodic overlap of illuminated lights increases the light intensity, which has been proven to better capture the attention of various birds.

The lights of the present invention (e.g. 10, 30, 35) can be similar to anti-collision strobe lights presently in aviation use. Preferably, the lights are xenon gas lights or LEDs. For example, LEDs have lower energy consumption than incandescent lamps and generally longer service lives. The lights preferably use LED bulbs. An incandescent 150 W light generally produces 2600 lumen whereas an LED light that produces 2600 lumen generally consumes only 25-28 W. Also, LED lights typically begin emitting light faster than incandescent lights. The lights preferably generate ultraviolet light (UV) in the spectral region of 180-400 nanometers (nm). This range of wavelengths is preferred to increase the visibility of the aircraft for birds, as many birds have a maximum absorbance of UV light at a wavelength of 370 nm.

Preferably, fan blades 117 and nose cones 119 are painted different colors (including fluorescent and iridescent) to increase visibility when illuminated with the lights (10 or 30) of the present invention. The chosen type of paint must be applied in such a way not to alter the balance of the fan disks and balance should be maintained.

### Visual Ecology of Birds and Humans

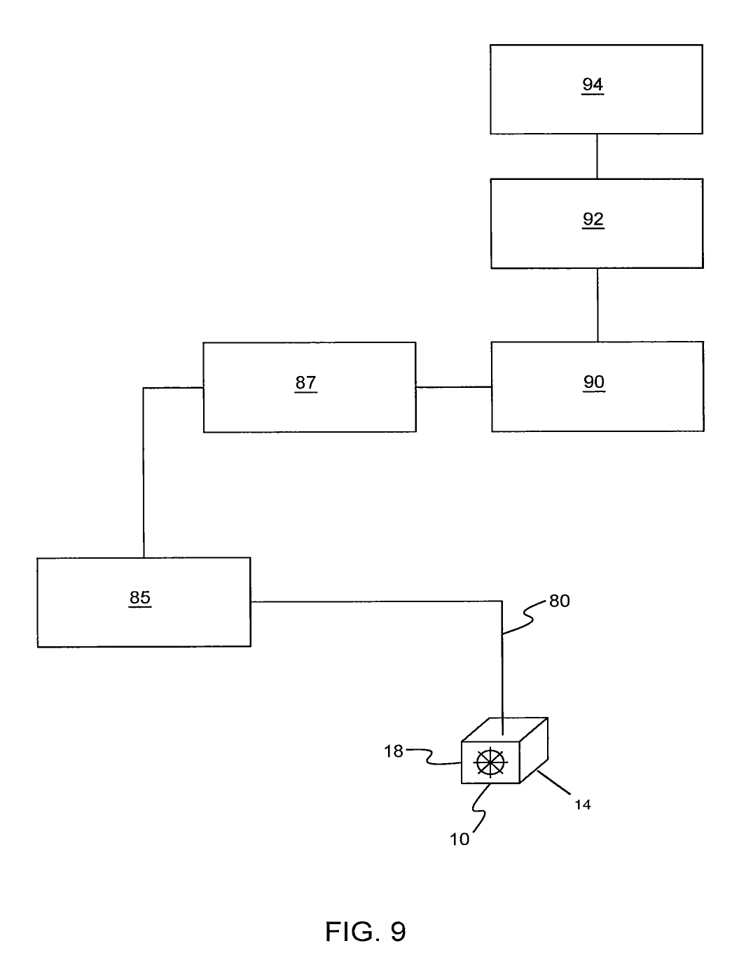

Birds are better able to see ultraviolet light than humans. FIG. 10 is a chart showing the UV portion of light spectrum only visible to birds and generally beyond normal human perception. Typically, avian ocular media do not absorb UV light before the light reaches the retina. The majority of birds have either a violet-sensitive single cone that gives them sensitivity to UV wavelengths or a single cone that gives them maximum sensitivity to UV wavelengths. Birds generally employ the perception of UV light in various visual tasks. A bird's violet/UV cone typically allows it to see objects reflecting UV light brighter when used in an achromatic task (brightness) such as seeing an approaching aircraft. Similarly, in a chromatic task (colors), birds can usually discriminate spectral stimuli according to the amount of reflective light in the UV part of the spectrum relative to the longer wavelength. This ability allows many bird species to differentiate amongst colors such as aircraft lights.

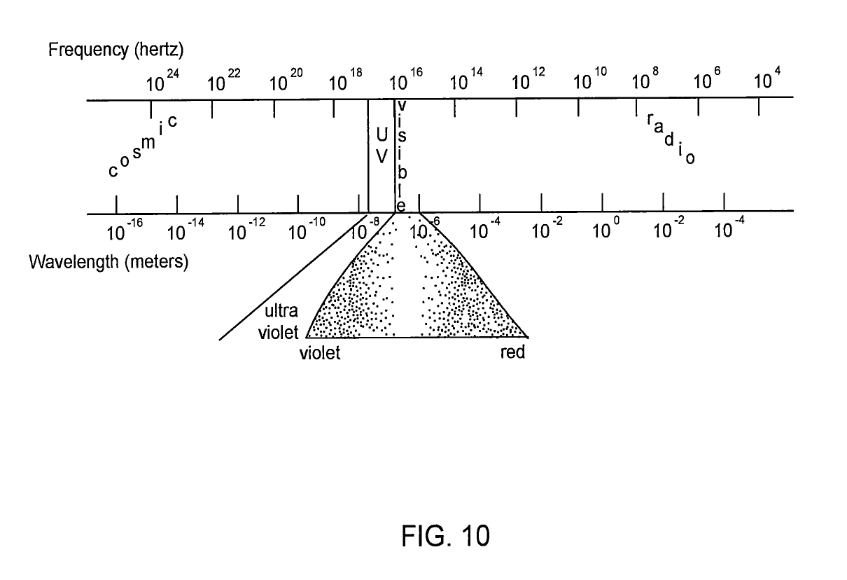

Humans usually have three different types of single cone photoreceptors each containing a different photo pigment that is either: short (SWS), medium (MWS) or long wavelength (LWS) sensitive. Thus, humans generally need three primary colors to identify any particular color and are said to be “tri-chromatic.” Most birds, by contrast, have a fourth spectral type of single cone and, therefore, require four primary colors to identify any particular color. This is referred to as “tetra-chromatic.” Each one of a bird's four cones has a distinctive maximal absorption peak. The fourth cone either has peak sensitivity in violet wavelengths and has considerable sensitivity in the near ultraviolet (UVA, 320-400 nm) region (VS cone: violet sensitive) or has maximum sensitivity in the UVA region (UVS cone: ultraviolet sensitive). The chart in FIG. 11 shows the common absorbance capability of avian vision including the UV part of the spectrum. Practical LED lights have efficiencies to produce UV lights in the ultraviolet range of 365 nm to 395 nm varying between 5-20%. Special LED lights that have a higher efficiency to emit light in the ultraviolet range can also be produced.

Furthermore, whereas average humans have about 200,000 receptors per mm² of retina, average birds, e.g. the house sparrow, have more than 400,000 receptors per mm² of retina. This receptor density can vary as the common buzzard has 1,000,000 receptors per mm² of retina. This increased density of avian photoreceptors evidences the excellent visual acuity of most birds. Thus, the lights of the present invention (10, 30, 35) preferably generate UV light to make aircraft more visible to birds.

### Lighting Details And Other Applications

The lights of the present invention preferably have a voltage rating compatible with the typical voltage for jet-powered aircraft, namely 28 volts. The lights (10 or 30) of the present invention preferably are able to withstand extreme changes in ambient temperature, pressure and local vibrations. This is commonly achieved by using aeronautically approved material in use today in aviation.

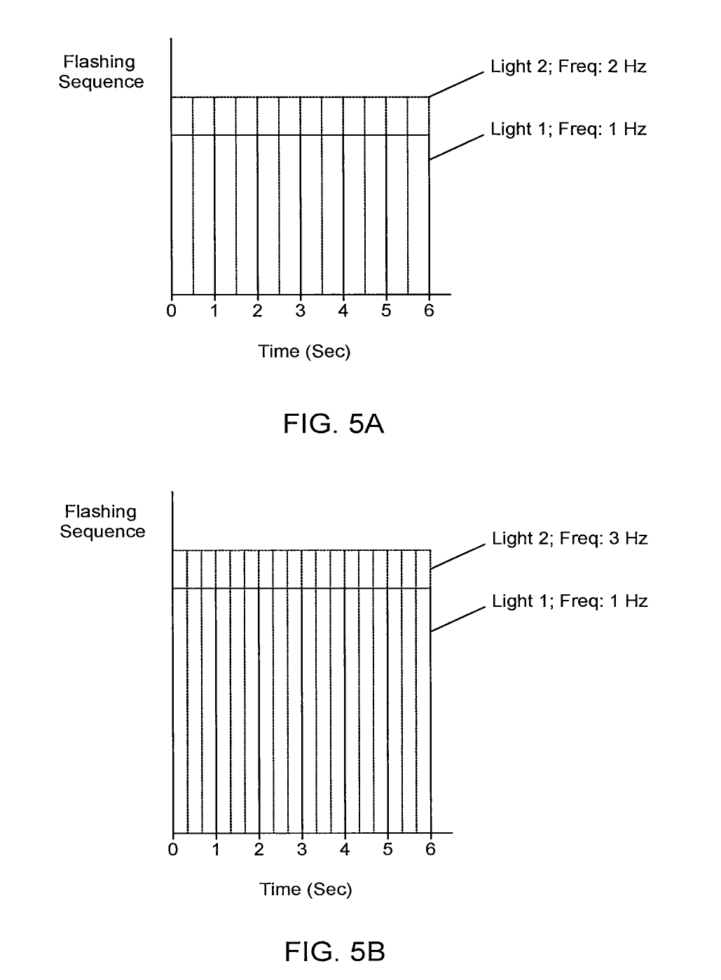

Referring now to FIG. 6, a flow chart depicting a preferred command sequence for the present invention is shown. It presents the conditions at which the lights (10 or 30) are turned on and the criteria necessary for them to stay on or turn off. The flowchart in FIG. 6 also shows conditions that will trigger the lights (10 or 30) to stay on in case of a “touch and go,” a rare occasion in airline operation but useful in flight crew training or general aviation and military transport.

Engine speeds, N1 and N2, are commonly detected in jet aircraft. N1 typically refers to the speed of the low-pressure compressor or fan speed and N2 typically refers to the speed of the high-pressure compressor or engine core. The engine speed and altitude limits are left to the operators to choose, as there are generally no established rules for operation that can serve all conditions. Instead, the limits can vary based on the types of missions flown by the aircraft. For example, the limits of engine speeds may be high for airline and military operations due to the heavy payloads typically carried by those aircraft. Conversely, engine speeds can be lower for general aviation where business jets fly at considerably lower payloads than their maximum capabilities.

Similarly, the altitudes limits are dependent to a great extent on type of operation and geographical locations. For example, an aircraft that operates primarily in tropical regions where there is an abundance of birds in the vicinity of airports may need to have a higher altitude limit to protect against bird strikes from birds of different species, e.g. bird species that fly close to the ground and those that fly at higher altitudes. For aircraft that operate mostly out of desert environments where birds are more rare near airports, a lower altitude limit can be used.

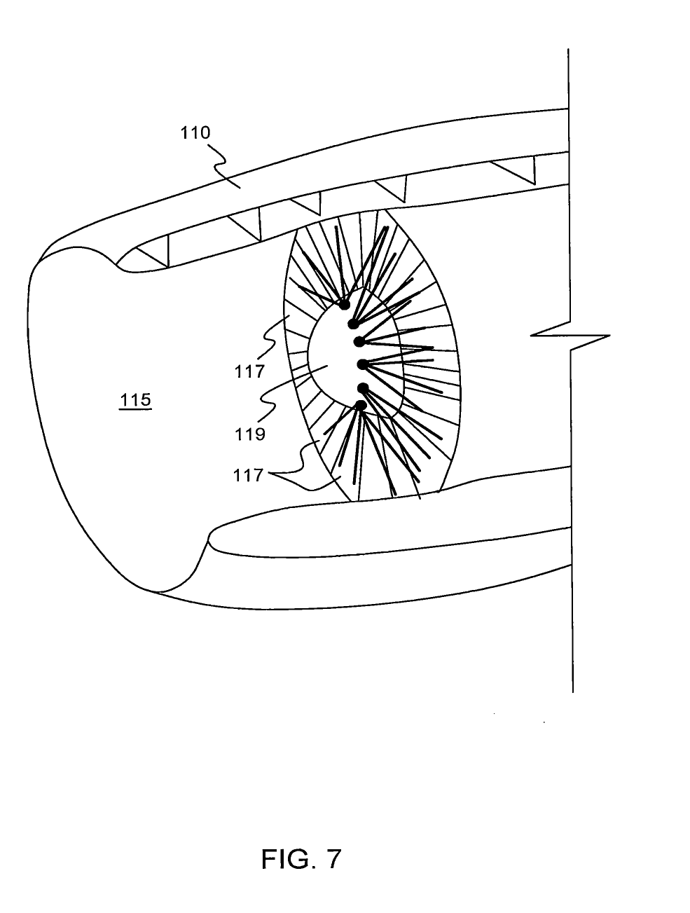

Referring now to FIG. 8, a top view of a Boeing 747 is shown with a preferred wiring schematic for the present invention. As shown, the fuselage lights 10 and nacelle lights 30 are preferably connected by wires 80 to a control panel and switches 90 in the aircraft cockpit. The lights 10 and 30 are also preferably connected to landing gear sensors 95. The sensors 95 preferably detect compression of an aircraft's landing gear at landing (not shown), which will trigger the lights 10 and 30 to turn off and keep them in that state should an aircraft's thrust reversers be deployed to slow the aircraft down. In the rare case of a “touch and go,” the thrust reversers would generally not be deployed. Accordingly in this situation, the lights 10 and 30 will stay activated until the aircraft reaches a pre-set altitude where the lights 10 and 30 would be deactivated.

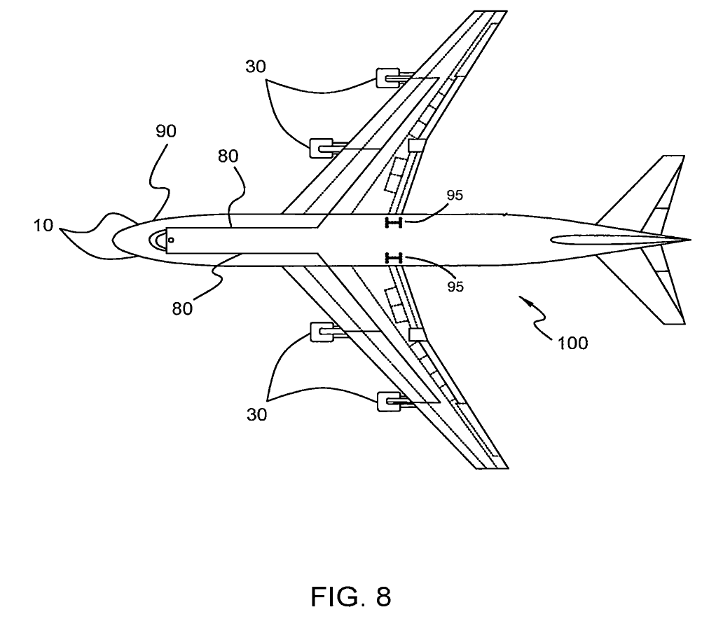

Referring now to FIG. 9, a simple schematic of a preferred embodiment of the present invention connected to an aircraft's electrical system is shown. As aircraft models generally vary in design, a generalized schematic that identifies common components is shown. As shown in FIG. 9, a fuselage light 10 with a focusing lens is mounted to the aircraft, preferably behind a glass panel 18 and a perforated plate 16 in an enclosure frame 14. The light 10 is preferably connected by wiring 80 via an electric bus 85 and circuit breaker(s) 87 to a control panel and switches 90. The control panel and switches 90 are preferably in an aircraft's cockpit. Also, preferably connected to the control panel 90 are a flashing frequency control 92 and engine speed (N1) sensor 94. The landing gear sensors 95 can also be connected to the control panel to control the lights 10 and 30 as described above.

The lights of the present invention (10, 30 and 35) are preferably installed flush, and contoured, with the fuselage 120 and the surfaces of the engine inlet 115 under clear glass panels 18. Referring back to FIG. 2c, the glass panels 18 are preferably adequate for this application, e.g. shatterproof tempered glass or cockpit window glass. The glass panels 18 are preferably affixed to perforated stainless steel plates 14 or stainless steel, perforated plates 16 covering the bulbs 12. Aluminum plates of the type used in aircraft construction can also be utilized. Between the metal plate 16 and glass panel 18 is sandwiched a seal 17 preferably made of flexible rubberized material to withstand the harsh environment and vibration of aircraft engine operation. As shown in FIG. 2c, a one-piece stainless steel frame 14 preferably surrounds this preferred embodiment assembly and holds it together. For a fuselage application, the frame 14 is held in place by stainless steel screws 19 and washers similar to wing mounted landing lights. For the engine inlet installations as shown in FIGS. 3 and 4, the frame 14 whose edges extend behind the inlet 115 wall is secured to the back of that wall by bolts 19 and washers in a manner that will preclude the assembly from being sucked into the fan blades 117. Access to the lights 10 and 30 will take place by removing the retaining frame 14 in case of a fuselage installation or by opening the fan case in case of an engine inlet installation.

The glass panel 18 preferably protects the lights from outside elements and foreign object damage (FOD). The glass panel 18 should not fog or allow condensation to reach the bulbs 12 through the seals 17.

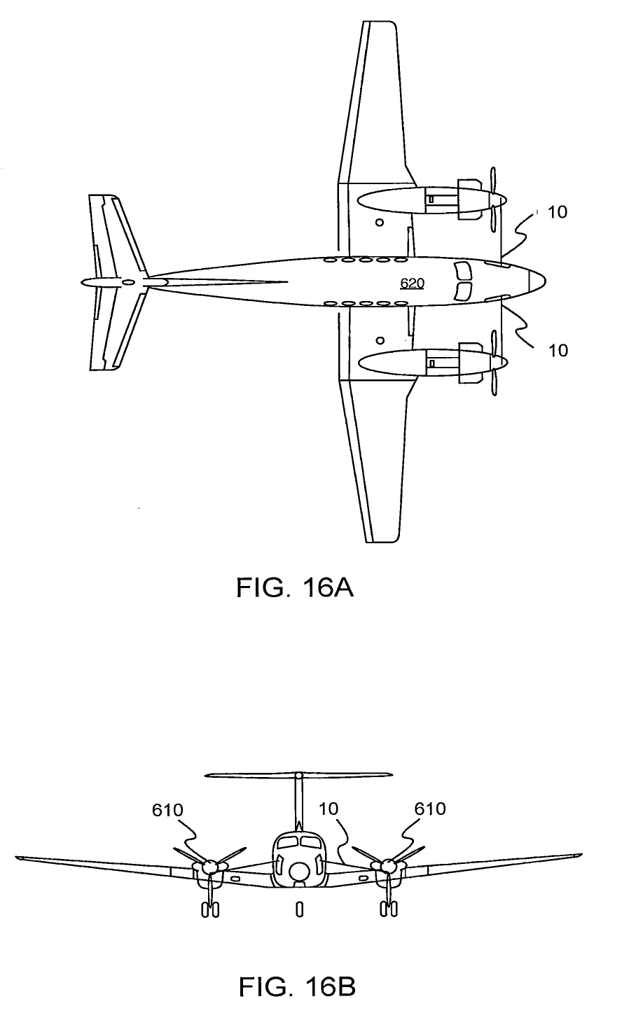

For propeller driven aircraft, engine cowl, pylon and fuselage (for twins) mounting are three possible installation alternatives proposed. Referring now to FIG. 16a, a common twin engine aircraft, a Beechcraft turbo propeller aircraft, is shown with the present invention installed. Fuselage lights 10 are mounted on the fuselage 620. A front view of the aircraft is shown in FIG. 16b. Preferably, the fuselage lights 10 are aimed at the bottom of the engines 610 to reduce reflection back into the cockpit of the aircraft.

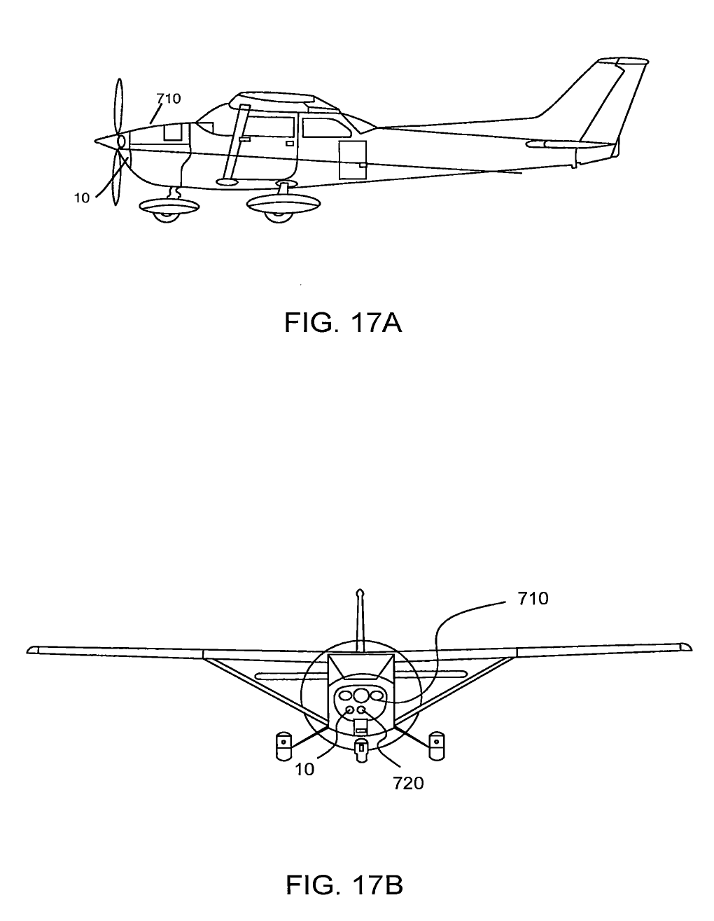

Referring now to FIGS. 17a and 17b, a preferred installation of the present invention is shown for another common propeller aircraft with a single engine, a Cessna. As shown in FIG. 17a, a light 10 is shown mounted on the engine cowl 710. Preferably, the light 10 is mounted on the bottom of the engine cowl 710 to minimize reflection of light into the cockpit of the aircraft. Referring now to FIG. 17b, the light 10 is shown preferably mounted next to landing light 720 on the engine cowl 710.

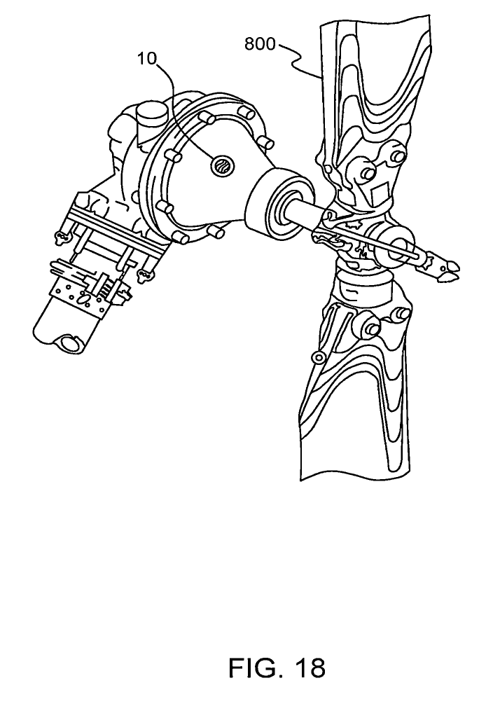

For helicopters, the lights are preferably mounted on the tail of the helicopter and flash on the rotor blades. Just as with jet engines, a bird strike can cause loss of control of the craft that can lead to catastrophic failure. The illumination of the rotor blades of the helicopter by the lights of the present invention reduces this possibility. Referring now to FIG. 18, a preferred installation of the present invention is shown on a helicopter tail rotor 800. The light 10 shines on the tail rotor assembly to alert birds.

As an operating methodology, aircraft and helicopters that normally operate at altitudes below 10,000 ft AGL preferably have the lights illuminated from engine start to shut-down by the pilot, preferably by an override switch.

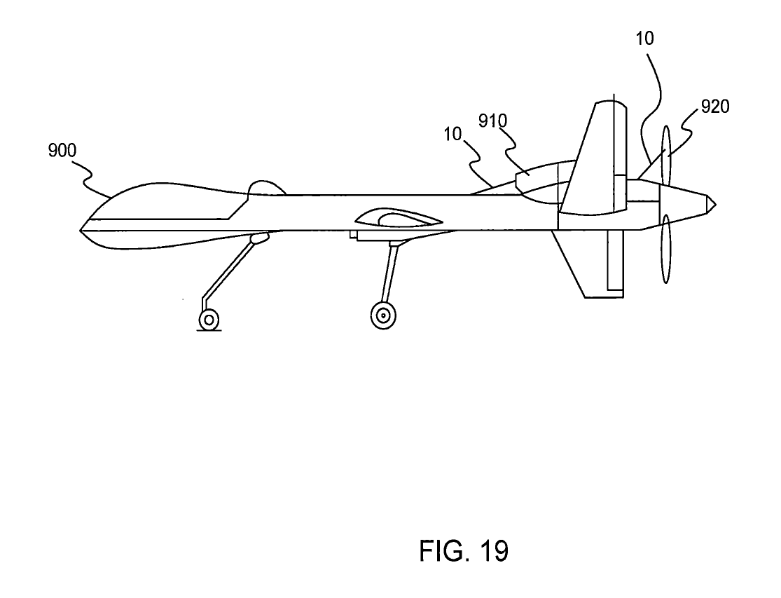

The present invention can also be installed on drones and Unmanned Air Vehicles (UAV) to illuminate the propellers and/or jet engines to reduce the possibility of bird strikes. Referring now to FIG. 19, a preferred installation of the present invention on a UAV is shown. As shown, lights 10 are preferably mounted on the UAV 900 in two locations, the engine inlet 910 and the UAV propellers 920, to alert birds.

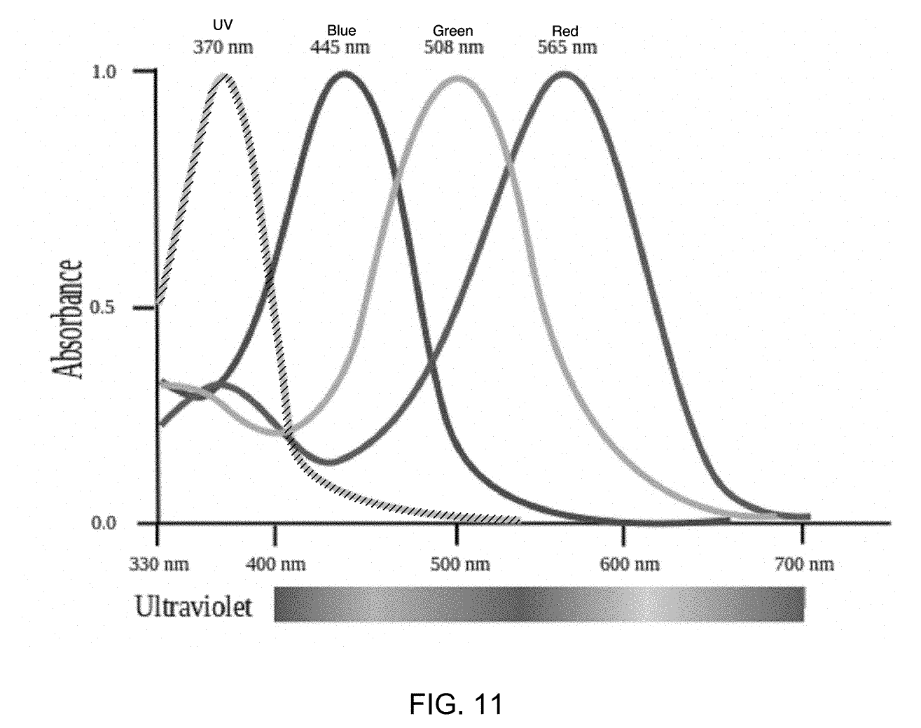

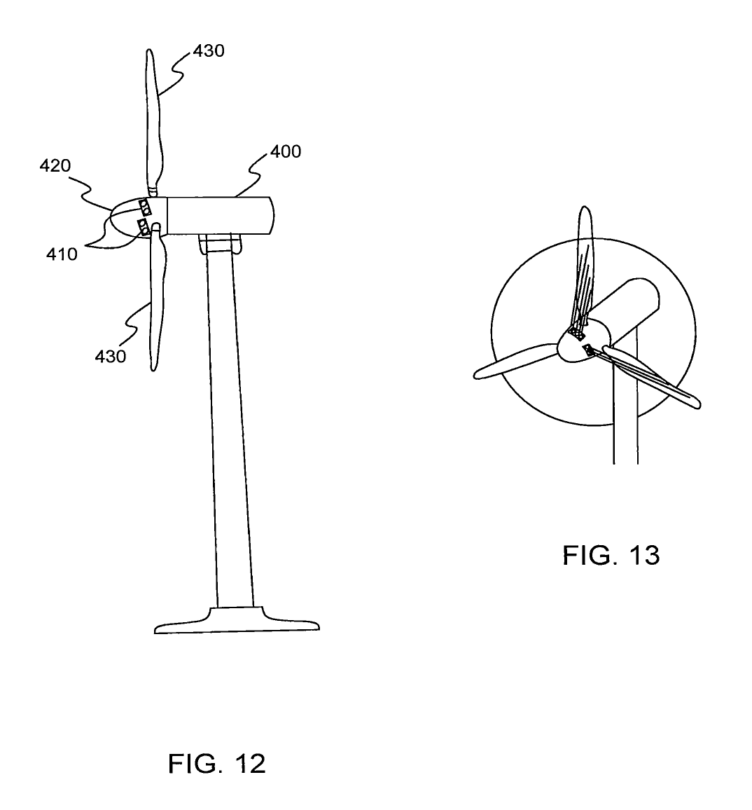

Referring now to FIGS. 12 and 13, an additional non-aviation application is disclosed. As shown in FIGS. 12 and 13, the present invention can be mounted on a wind turbine 400. Preferably, lights 410 are installed in a radial layout on a hub 420 of the wind turbine 400. By mounting lights 410 on the hub 420, light can illuminate blades 430 even the blades have variable pitch. Similar to the aircraft installation of the present invention, lighting the blades 430 with the lights 410 will make blades more visible, and therefore more avoidable, for birds. This reduces the incidence of bird strikes.

The flashing frequency of the lights 410 is preferably governed by the turbine's speed. The flashing frequency is preferably set between 2 Hz to 3 Hz at the highest allowable turbine rotational speed. Just as in the aviation application described above, the lights 410 overlap in flashing to avoid a dark state and in order to heighten the attentiveness of the birds. Alternatively, the flashing frequency of the lights 410 can be set at any rotational turbine speed or even when blades 430 are stationary.

In addition to the immediate benefits of the present invention, over the time birds are likely to learn to avoid aircraft and wind turbines equipped with the present invention even earlier or even move their nests and roosts away to other areas.

### Alternative Helicopter Lighting Embodiment

### UV Light That Shines on Fluorescent Paint Peak Shifts Into the Violet Spectrum

### Photochemistry

Fluorescence is often defined as the absorption by a surface of electromagnetic radiation at one wavelength and its reemission from that surface at another lower energy and, therefore, longer wavelength. When the source or excitation light is from a UV source, the secondary or emitted light is typically in the visible spectrum. In most cases, the emitted light has a longer wavelength and lower energy than the source. When a UV light shines on a surface with fluorescent material, e.g. fluorescent paint, an orbital electron of an atom in the fluorescent material absorbs a photon and is excited to a higher energy state S₁ from its ground state S₀. Upon returning to its ground state once the light source is removed, the electron emits a photon that in most cases appears as radiated visible light. Although there are multiple ways for the electron relaxation, the predominant one is through the emission of a photon (light) and heat.

Excitation: S₀+h√ₑₓ [symbol] S₁

Fluorescence: S₁ [symbol] S₀+hₑₘ+heat

Where: S₀=the ground state, S₁=the excited state, h is the photon energy, h=Planck's constant and =light frequency, hₑₓ=excited photon energy, hₑₘ=emission photon energy.

The source wavelength thus undergoes a shift known as a Stokes shift that is due to the energy loss from the time a photon is absorbed and a new one is emitted. Typically, the electrons are raised to a higher energy level in a short period, e.g. 1×10⁻¹⁵ second. Similarly, the return to the ground state is in the order of 1×10⁻⁹ second.

Whereas passenger jets have pressurized cabins that require strong structures to withstand, in part, the cyclical pressure differentials of pressurization, the majority of helicopters do not have pressurized cabins. As a result, helicopter airframes are much lighter in construction and have large transparent areas to improve pilot visibility. Hence, helicopters can be very susceptible to avian strikes and the resulting damage. Given the lighter mass of helicopters, strikes can inflict a de-stabilizing effect and render the aircraft difficult to control or uncontrollable.

Moreover, helicopters generally rely on the main rotor for lift and thrust. Thus, the main rotor is a critical system for safe operation of this type of aircraft. A bird strike against a helicopter is likely to inflict a much higher degree of damage to a helicopter than on a large jet. Tail rotors are also particularly vulnerable to severe damage from bird strikes due to their smaller blades and high rotational speed. Tail rotors are generally used for the directional stability of helicopters. Minor damage to a tail rotor can have major impact on flight stability.

FIG. 18 and paragraph 36 above refer to a preferred embodiment for a tail rotor installation for a helicopter lighting system. Given the relatively fragile nature of rotor aircraft, an expanded system with increased visibility for other parts of the aircraft is desired to reduce or eliminate bird strikes.

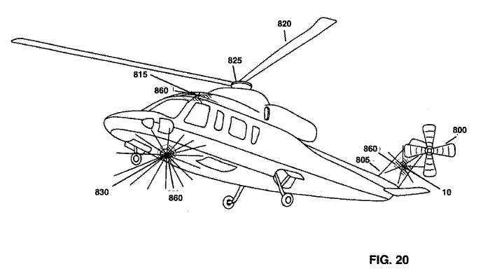

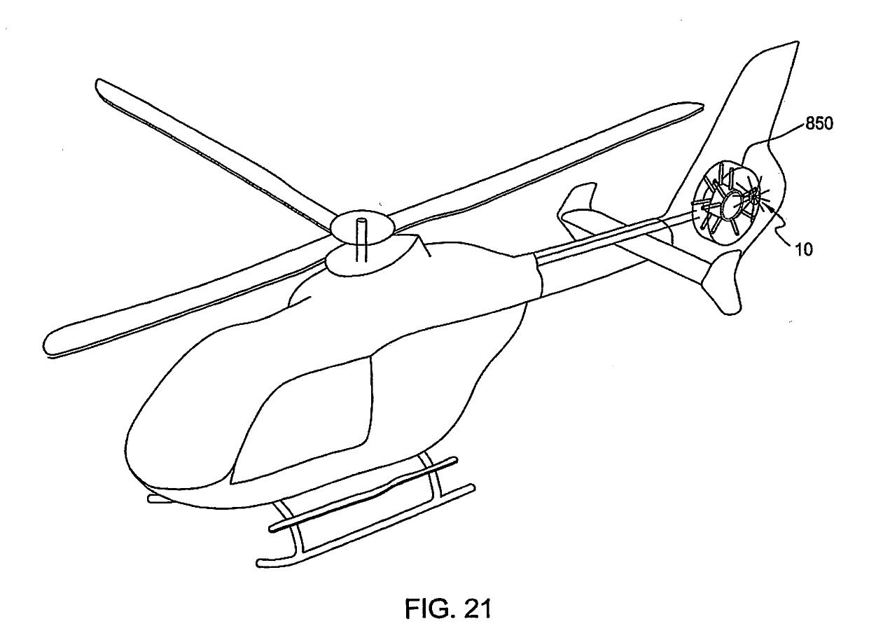

Referring now to FIG. 20, a perspective front view of a preferred embodiment for a helicopter lighting system is shown. Similar to FIG. 18 above, a light 10 is mounted on the tail 805 of a helicopter so that the light shines on the tail rotor 800, preferably the tips of the tail rotor 800. For encased or cowled tail rotors, the light 10 is preferably mounted to the cowl 850 as shown in FIG. 21. The light 10 is preferably mounted on the rear of the cowl 850 since most strikes occur from the side or front of the aircraft and not the rear.

Furthermore, referring to FIG. 20, a rotor light 815 is preferably mounted on the top of the helicopter that emits ultraviolet (UV) light on the rotor 820 and vertical shaft 825. The rotor 820 is preferably painted with a fluorescent paint that alternates with an adjacent shiny and reflective surface. Possible patterns of fluorescent and reflective surfaces include vertical, diagonal, or horizontal stripes and/or spots. In general, it is preferred that these alternating surfaces are at or near the tips of the rotor 820. The fluorescent paint on the rotor 820 absorbs UV light and that causes the UV light to shift its peak to the spectrum of light visible to humans, such as the violet spectrum of light, when emitted, whereas the reflective surface of the rotor 820 merely reflects the UV light as is. The net effect of juxtaposing these two surface finishes of the rotor 820 creates a strong contrast that captures the attentiveness of birds. The rotor light 815 is preferably at the center of a roundel 860 where light from the rotor light 815 shines on the roundel 860.

Preferably, a belly light 830 is affixed on the belly of the helicopter (and not the landing gear or landing skids of the helicopter). The belly light 825 preferably shines on belly surfaces painted similarly to the main rotor described above and/or a roundel. As shown, the belly light 830 is mounted to the belly of the helicopter so that birds below the aircraft can see it as it flies above them.

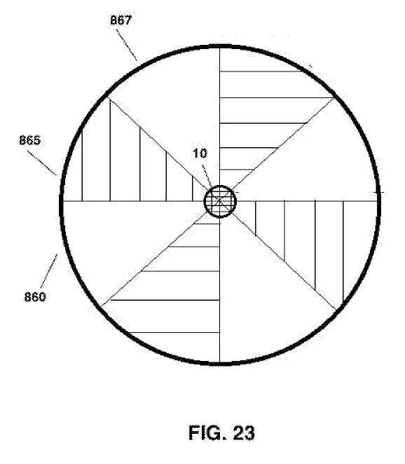

The belly light 830, tail rotor light 10 and main rotor light 815 are preferably PAR36 bulbs of 4.5″ in diameter. The belly light 830, tail rotor light 10 and main rotor light 815 are preferably mounted at the center of a roundel 860. The lights 830, 10, and 815 preferably project just above the surface of the roundel 860 so that the lights shine outwardly and onto the surface of the roundel 860. A preferred embodiment of the tail rotor light 10 in the center of a roundel 860 is shown in FIG. 23. The surface of the roundel 860 (and the other roundels described above) preferably comprises alternating fluorescent painted surfaces 865 and reflective surfaces 867.

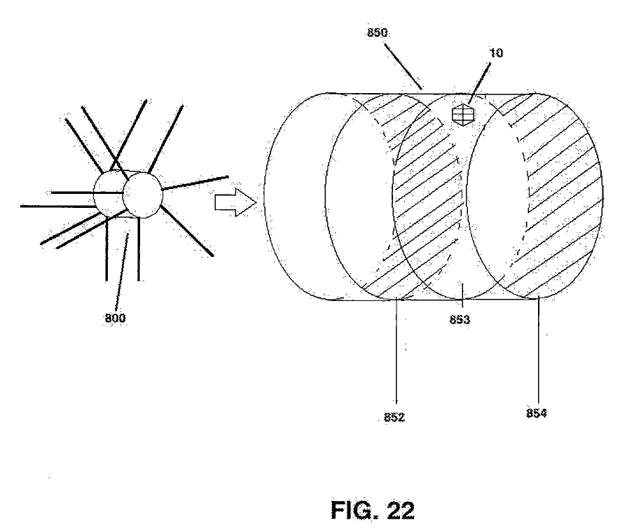

Referring now to FIG. 22, the exploded view schematic of a cowled tail rotor is shown. Preferably, the light 10 is mounted within the cowl 850. The cowl 850 preferably has two outer rings 852 and 854 with fluorescent painted interior surfaces and a center ring 853 with a reflective surface. Thus, the light 10 preferably shines on each of the rings 852, 853, and 854.

The fluorescent painted surfaces described above are preferably painted with a UV-curable epoxy-silicone-acrylic paint hybrid mixture. The hybrid mixture is preferably mixable with acrylic paint and other existing aircraft paints. Preferably, the hybrid mixture comprises 5% of the total paint when mixed with aircraft paint applied to surfaces described above. The UV light shining on the fluorescent paint preferably provides a fluorescent excitation peak at 350 nm. This results in a fluorescent emission spectrum that has a shift of wavelength peak higher into the violet light (400-445 nm) spectrum and higher wavelengths of human visible light such as blue light (475 nm), green light (510 nm), yellow light (570 nm), orange light (590 nm), and red light (650 nm).

The helicopter lighting system preferably uses the frequencies and wavelengths as disclosed above as well as the cockpit control systems and methodology as disclosed above. As discussed above, helicopters lights preferably illuminate upon engine start and shut down with engine shut down. This embodiment will preferably be on an independent circuit from navigation lights and an override switch allows the pilot to turn off the lights any time. Upon engine shut down, the circuit will preferably reset to turn back on upon engine restart.

### Alternative Airplane Embodiment

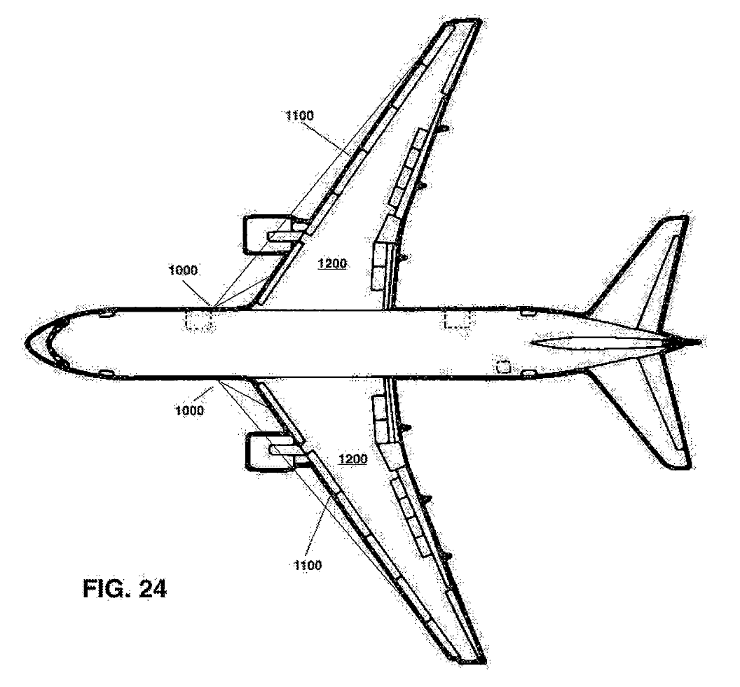

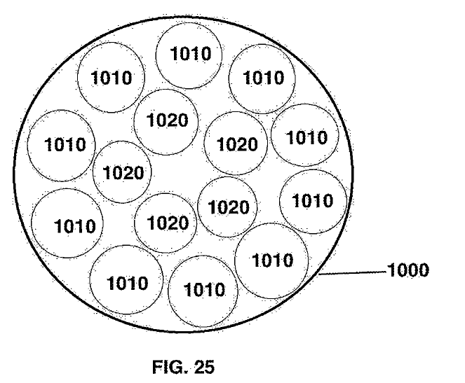

Referring now to FIGS. 24 to 25, another alternative embodiment of the invention is shown. This alternative embodiment is preferably used with airplanes. Most airplanes have a standard wing illumination light on the fuselage. In this embodiment, those wing illumination lights are preferably replaced with LED lamps 1000 shown in FIG. 25. The LED lamps 1000 preferably have two concentric rings of bulbs. Preferably, there is a ring of UV LED bulbs 1010 on the perimeter of the lamp 1000, able to emit UV light (e.g. 350 nm) and a ring of white bulbs 1020, able to emit D65 (6500 Kelvin) light, in an inner circle. Preferably, the lamp 1000 is 4.5″ in diameter and a PAR36 lamp. The preferred lamp further has 100 w power; amperage 3.5 A@28 v; lumens 1500; and, candelas 150,000. (In the engine inlet role, the preferred light will have 50,000 candelas.) This lamp can also be used in the embodiments described above. Alternately, light emitting diodes of other types can be used such as “chip on board” configurations.

The lamps 1000 preferably replace the wing illumination lights on an aircraft's fuselage as shown in FIG. 24. The UV bulbs 1010 are preferably aimed to shine light at the leading edge of the aircraft wings 1100. Preferably, lenses are used to assist in directing the light to the leading edge 1100. The lenses are shaped/configured based on the aircraft type on which the system is installed. The leading edges 1100 are preferably painted with fluorescent paint, as described in the above embodiment, that preferably shifts the UV light to the human visible spectrum, e.g. violet (e.g. 400-450 nm) and other colors like blue (e.g. 475 nm), green (e.g. 510 nm), yellow (e.g. 570 nm), orange (e.g. 590 nm) and red (e.g. 650 nm). A contrast is, therefore, created between the reflective painted edge 1100 and the unpainted wing surfaces preferably making it more visible to birds. The painted edge 1100 can be slats that, when deployed, expose an area behind the slats that can also be painted in an alternating fashion to create reflective surface juxtaposed with painted surfaces (similar to the roundels described above).

The inner circle of bulbs 1020 are preferably aimed to shine white light at upper wing surfaces 1200. This is to create standard aircraft lighting and it also, preferably, creates further contrast with the UV and shifted light described above.

### Building Lights

Annually, it is estimated that roughly a billion birds (about 5% of the migratory bird population) die in the USA due to collision with the glass windows of buildings. For multiple reasons, birds are often not able to see the glass panes and, therefore, sometimes collide with them. Many birds are consequently severely injured or killed. The building strikes predominantly occur in the spring and fall when birds migrate. These building strikes cause a severe decline in the migratory bird population. Nocturnal species, such as such as yellow-bellied sapsuckers, northern flickers, brown creepers, hermit thrushes, and white-throated sparrows are particularly affected.

An alternative embodiment of the present invention can reduce or eliminate these building strikes by strategically installing LED UV lights on the inside of select window panes to shine on fluorescent, translucent designs pasted on the same side of the panes. Preferably, a portion of the UV light passes directly through the windowpane while the remaining UV light is absorbed by the fluorescent designs. The fluorescent paint of those designs preferably causes the portion of UV light to shift from the UV to the spectrum visible to humans, e.g. the violet light spectrum. The strong contrast thus created by the fluorescent designs and the escaped UV light will increase the visibility of the windowpane to birds so they can avoid the window pane/building and continue their flights.

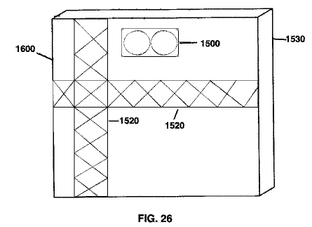

Referring now to FIG. 26, a front perspective view of a preferred embodiment of the invention is shown installed on an interior side of a windowpane 1600. Lights 1500, similar to the LED UV lights described above, are preferably installed in the pane 1600. The lights 1500 are preferably powered by the electric power of the building and represent a small draw and low power consumption. Alternatively, the lights 1500 can be supplied power individually from a solar panel (not shown) attached to an adjacent window and utilize the building power or a battery as a back-up during overcast days. The lights 1500 preferably shine UV light on fluorescent translucent designs 1520.

The designs 1520 are preferably pasted with an adhesive on the inside of the pane 1600. The designs 1520 can be beneficial in reducing energy consumption to cool or heat the building as the designs will partially block sunlight from reaching the interior of the building and insulate the inside from heat losses to the outdoors. Preferably, a non-transparent backing 1530 is applied to the windowpanes 1600 so that light from the device will remain concentrated on the designs 1520 and not diffuse into the interior of the building. The backing 1530 would also shield the eyes of building occupants. For buildings where the top or sides of the building have foliage, this alternative embodiment installation can also be effective to deter birds from landing or roosting there.

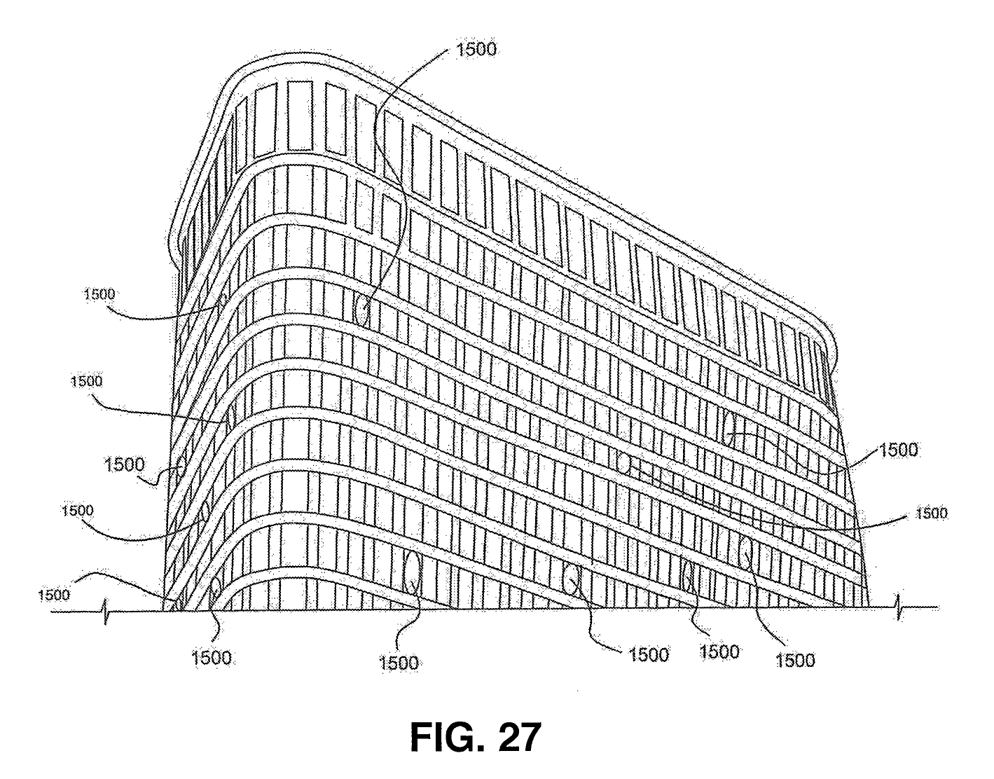

This alternative preferred embodiment installation is preferably installed on only a subset of the panes on a given building, instead of on each and every windowpane. As shown in FIG. 27, preferably, the invention is installed on at least on one window 1600 per floor per building-side and in a staggered fashion so to spread the lit panes 1600 throughout the building facade. Wide buildings will benefit from more than one light per floor, whereas for tall and narrow buildings, one light 1500 per floor should suffice. Preferably, the LED lights 1500 flash on the fluorescent translucent pane designs 1520 at frequencies of 1 to 3 HZ. This should significantly increase the visibility of the panes and that of the building to birds at any time of day or night. The lights 1500 can be installed in series and programmed to switch on and off at a prescribed time of day or turned on and off manually. The lights 1500 can also be controlled by a daylight sensor (not shown) that switches them on and off without any human input. The lights 1500 can alternatively be individually installed and not connected to other lights 1500.

Thus, an improved lighting system is described above that reduces the incidence of bird strikes on aircraft and buildings. In each of the above embodiments, the different positions and structures of the present invention are described separately in each of the embodiments. However, it is the full intention of the inventors of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A helicopter lighting system for a helicopter having a tail, a tail rotor, a belly, a roof, a main rotor and a vertical shaft, the lighting system comprising:
at least one light mounted on the tail aimed at the tail rotor, where illumination from the light comprises ultraviolet light and the at least one light flashes at a pre-determined frequency; and,
the tail rotor having a surface at least partially coated in fluorescent paint that shifts the ultraviolet light to light in the visible spectrum.

2. The helicopter lighting system of claim 1 where the ultraviolet light is between 300 and 400 nm in wavelength.

3. The helicopter lighting system of claim 1 where the pre-determined frequency is between 1 and 3 Hz.

4. The helicopter lighting system of claim 1 where the at least one light is mounted on a roundel having alternating fluorescent paint and reflective surfaces where the fluorescent paint shifts the ultraviolet light to light in the visible spectrum.

5. The helicopter lighting system of claim 4 where the lighting system further comprises at least one belly light mounted on a second roundel having fluorescent paint and reflective surfaces mounted on the belly, where illumination from the belly light comprises ultraviolet light and the at least one belly light flashes at a predetermined frequency, and further where the ultraviolet light is shifted to light in the visible spectrum by the fluorescent paint.

6. The helicopter lighting system of claim 5 where the lighting system further comprises at least one main rotor light mounted on the roof, where illumination from the main rotor light comprises ultraviolet light that shines on the main rotor and the main rotor comprises fluorescent paint and reflective surfaces, where illumination from the main rotor light is shifted to light in the visible spectrum by the fluorescent paint on the main rotor.

7. The helicopter lighting system of claim 6 where the fluorescent paint is a UV-curable epoxy-silicone-acrylic paint mixture.

8. An aircraft lighting system for an aircraft where the aircraft has a fuselage and a wing with a leading edge and an upper surface, the lighting system comprising:
a lamp mounted on the fuselage where the lamp comprises an outer circle of light emitting diodes that emit ultraviolet light and an inner circle of light emitting diodes that emit white light, where the outer circle of light emitting diodes is aimed at the leading edge of the wing and the inner circle of light emitting diodes is aimed at the upper surface of the wing.

9. The aircraft lighting system of claim 8 where the leading edge of the wing is painted with fluorescent paint.

10. The aircraft lighting system of claim 9 where the fluorescent paint shifts the ultraviolet light to light visible to humans.

11. The aircraft lighting system of claim 8 where the outer circle of light emitting diodes flashes at a pre-determined frequency between 1 and 3 hertz.

12. The aircraft lighting system of claim 9 where the fluorescent paint is a UV-curable epoxy-silicone-acrylic paint mixture.

13. The aircraft lighting system of claim 8 where the leading edge of the wing has sections alternating between sections painted with fluorescent paint and sections that are reflective and not painted with fluorescent paint.

14. A building lighting system for buildings with a windowpane, the lighting system comprising:
at least one light mounted on an interior side of the windowpane, where illumination from the light comprises ultraviolet light and the at least one light flashes at a pre-determined frequency on a fluorescent translucent design applied to the interior side of the windowpane, where the ultraviolet light is shifted to light visible to humans by the fluorescent translucent design.

15. The building lighting system of claim 14 where the ultraviolet light is between 300 and 400 nm in wavelength.

16. The building lighting system of claim 14 where the pre-determined frequency is between 1 and 3 Hz.

17. The building lighting system of claim 14 where the window pane has a non-transparent backing.
